(19) United States
(12) Patent Application Publication
(10) Pub. No.: US 2008/0201524 A1
(43) Pub. Date: Aug. 21, 2008

(54) SYSTEM AND METHOD FOR INCREASING VIDEO SERVER STORAGE BANDWIDTH

(75) Inventors: MIHAI G. PETRESCU, Schwenksville, PA (US); Todd S. Roth, Shadow Hills, CA (US); Hilton S. Creve, Culver City, CA (US); Tung M. Tran, West Hills, CA (US)

Correspondence Address: Duane Morris LLP;IP Department (Harris Corp.), 505 9th Street N.W., Suite 1000, Washington, DC, 20004-2166, US

(73) Assignee: HARRIS CORPORATION, Melbourne, FL (US)

(21) Appl. No.: 11/675,556

(22) Filed: Feb. 15, 2007

(51) Int. Cl. G06F 12/00

(52) U.S. Cl. 711/114

(57) ABSTRACT

A system and method for storing data in a data storage system. A data storage system is provided having a plurality of hard disk drive units each of which includes a plurality of hard disk storage devices. A first logical volume and a second logical volume may be formed for storing data such that the logical volumes include a respective set of hard disk storage devices for each of the plural hard disk drive units where each of the sets of hard disk storage devices are mutually exclusive. A first data set and a second data set may then be stored in the first and second logical volumes, respectively.

### BACKGROUND

Magnetic disks have largely supplanted video tape as the storage medium of choice. Currently large volumes of random access storage may be provided in a video server by hard disk drives. Each hard drive includes one or more disks mounted on a common axle driven by a motor. Each disk may include thousands of circular tracks in which data can be stored. The tracks are provided in a storage area that extends from an inner circular edge at about ¼ of the radius of the disk to the outer circular edge of the disk. A respective read/write head for each side of each disk may be mounted on one of the branches of a common comb-shaped carrier typically referred to as a comb. The comb is turned by a motor called an actuator to move the heads radially thereby positioning the heads above one of a multitude of tracks on the disk to access (read or write) information from a selected track. When the heads are in position to access information on a track then each of the heads on the comb is in position to access a respective track on a respective side of a disk without further substantial movement of the comb. The tracks on respective sides of the disks are typically referred to as a cylinder.

Generally in current video servers, plural multimedia programs may be stored in a redundant array of independent disks (RAID) type storage system. During data storage, a respective portion of a file is stored in each of the other hard drives in a round robin manner, and then a parity portion is calculated and stored in a parity or redundant drive. Round robin is a method of taking turns during repeated access cycles in which each unit gets one turn in each turn cycle, and the units take turns in the same order during each turn cycle. Storing consecutive portions of the same file in multiple drives in a round robin manner is known in the art as data striping. If any one drive in the RAID system fails during a read, then all the information will automatically be available by processing the information from the remaining drives.

The files for a multimedia program generally include at least one video file, at least one audio file, and multiple control files. The video files for a one hour program, even in a highly compressed format, generally require several gigabytes of storage, and typically many cylinders are required for each video program. Typical multimedia data servers are able to simultaneously provide multiple program streams. That is, the streams of several programs may be input and/or output simultaneously on several independent channels. This requires simultaneous disk access to multiple files. In this scheme several files are repeatedly accessed over short periods of time. The comb moves at high speeds back and forth between the tracks for the required files as short portions of each file are sequentially accessed.

By definition, a broadcast video server must base all channel capacity calculations on a worst-case system loading. Generally, channel capacity may be defined as:

Channel capacity=(Storage bandwidth)/(Channel data rate) (1)

Therefore, a twelve channel server must support twelve simultaneous independent channels. Similarly, a 120 channel server must support 120 simultaneous channels, and so on. Whether the same media is playing back in all channels, or different media in each channel, performance and quality-of-service (QoS) must be guaranteed. Furthermore, whether all drives are functioning, or one or two drives fail, performance and QoS must still be guaranteed.

Traditional storage area network (SAN) design has developed around the concept of the RAID set and its associated “aggregate” bandwidth. This aggregate storage system bandwidth is created by striping data across individual drives. FIGS. 1 and 2 are representations showing prior art data striping and bandwidth aggregation. With reference to FIG. 1, data striping involves breaking media files 100 down into data blocks and calculating parity. Depending upon the data protection strategy, either single, as in RAID level 3, or multiple parities may be calculated. Contiguous data 112, 114, 116 and associated parity blocks 113, 115, 117 are organized into data stripes 120, 122, 124 such that the total number of blocks is equal to the number of drives in a RAID set. Calculating optimal block size to optimize data transfer performance is necessary; for example, too small is inefficient, too large unwieldy. With reference to FIG. 2, a data stripe 120 may then be written across all the drives constituting the RAID set. As illustrated in FIG. 2, drives 201 through 216 are located on a first physical drive chassis or DAE1 251, drives 217 through 232 are located on DAE2 252, and drives 233 through 248 are located on DAE3 253. This data striping process allows each drive to contribute in an additive manner to both the capacity and the bandwidth of the aggregate logical volume by the following relationship:

Logical volume=(RAID set)−(#drives) (2)

Non-interruptive expansion may be limited by increasing the storage capacity through additional RAID sets. RAID set bandwidth generally may be expanded by increasing the number of member drives in each set, a process requiring adding drives to the array and re-striping data. Through the integration of data-striping, advanced RAID calculation (Error Correction Checking (ECC) parity) and a media-oriented file system may be realized in a distributed software environment. FIG. 3 is a prior art media delivery system. With reference to FIG. 3, a prior art media delivery system 300 provides a SAN for a real-time broadcast environment. System bandwidth is aggregated 310 in the SAN 312, and bandwidth is distributed and shared 320 across all connected host servers 322. For example, data striping occurring across drives D1 through D64 builds SAN bandwidth. The total SAN bandwidth may then be divided among the host servers 322 whereby network access arbitration may be managed to ensure bandwidth availability and deterministic performance. Any residual bandwidth may be utilized for Serial Data Interface (SDI) Input/Output expansion and/or external connectivity. For example, a system designed to have a 4 Gbps aggregate bandwidth is not created by connecting four 1 Gbps systems together; rather, each piece of media on the SAN has 4 Gbps shared access. FIG. 4 is a graphical illustration of storage bandwidth versus drive configuration in prior art SAN Fiber Channel infrastructures. With reference to FIG. 4, as systems transition from a 2 Gbps to 4 Gbps Fiber Channel infrastructure, the maximum aggregate bandwidth increases from 4 to 6 Gbps (based on a 48 drive ECC RAID set). Thus, 6 Gbps of bandwidth may only support 100 channels of compressed high definition (HD) media (60 Mb MPEG2); however, real-time broadcasting may require systems with hundreds of real-time channels.

Thus, with the adoption of HD broadcasting and its commensurate requirement for increased storage capacity and bandwidth, the need for scalability has increased. By applying the latest advances in the deterministic performance and dual-ported redundancy of Fibre Channel (a gigabit speed network technology for storage networks) larger, more capable and redundant systems must be built to meet the needs of the media industry. Therefore, a need exists in the art for a system and method for increasing video server storage bandwidth.

Accordingly, there is a need for a method and apparatus for a novel method and system that would overcome the deficiencies of the prior art. Therefore, an embodiment of the present subject matter provides a novel method for storing data in a data storage system. The method comprising the steps of providing a data storage system having a plurality of hard disk drive units each of which includes a plurality of hard disk storage devices and forming a first logical volume for storing data such that the first logical volume includes a first set of the hard disk storage devices for each of the hard disk drive units. A second logical volume for storing data may be formed such that the second logical volume includes a second set of the hard disk storage devices for each of the hard disk drive units. A first data set may be stored in the first logical volume, and a second data set may be stored in the second logical volume, wherein the first and second set of hard disk storage devices are mutually exclusive. An alternative embodiment of the present subject matter may further include the steps of arranging the first set of hard disk storage devices into a first redundant array of independent disks and arranging the second set of hard disk storage devices into a second redundant array of independent disks.

Another embodiment of the present subject matter provides a novel data storage system. The data storage system includes a plurality of hard disk drive units each of which includes a plurality of hard disk storage devices and a controller which segregates a portion of an aggregate storage volume of the data storage system. The aggregate storage volume may be segregated into a first logical volume for storing data such that the first logical volume includes a first set of the hard disk storage devices for each of the hard disk drive units, and a second logical volume for storing data such that the second logical volume includes a second set of said hard disk storage devices for each of the hard disk drive units, wherein the first and second set of hard disk storage devices are mutually exclusive. The system further comprises a first writing circuit for storing a first data set in the first logical volume and a second writing circuit for storing a second data set in the second logical volume. An additional embodiment of the present subject matter may further include a second data storage system operatively connected to the first storage system to provide back-up storage capacity to the first data storage system. In an alternative embodiment, the controller may be replaced by a first controller and a second controller. The first controller segregates a first portion of an aggregate storage volume of the data storage system into the first logical volume for storing data such that the first logical volume includes the first set of the hard disk storage devices for each of the hard disk drive units. The second controller segregates a second portion of the aggregate storage volume of the data storage system into the second logical volume for storing data such that the second logical volume includes said second set of the hard disk storage devices for each of the hard disk drive units, wherein said first and second set of hard disk storage devices are mutually exclusive.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIG. 1 is a representation showing prior art data striping and bandwidth aggregation.

FIG. 2 is a representation showing prior art data striping and bandwidth aggregation.

FIG. 3 is a prior art media delivery system.

FIG. 4 is a graphical illustration of storage bandwidth versus drive configuration in prior art SAN Fiber Channel infrastructures.

FIG. 5 is a data storage system according to an embodiment of the present subject matter.

FIG. 6 is a data storage system according to another embodiment of the present subject matter.

FIG. 7 is a data storage system according to an alternative embodiment of the present subject matter.

FIG. 8 is a data storage system according to a further embodiment of the present subject matter.

FIG. 9 is a flowchart illustrating a method for storing data in a data storage system according to an embodiment of the present subject matter.

FIG. 10 is a representation of the data storage redundancy capabilities of embodiments of the present subject matter.

### DETAILED DESCRIPTION

With reference to the figures where like elements have been given like numerical designations to facilitate an understanding of the present subject matter, the various embodiments of a system and method for increasing video server storage bandwidth are herein described.

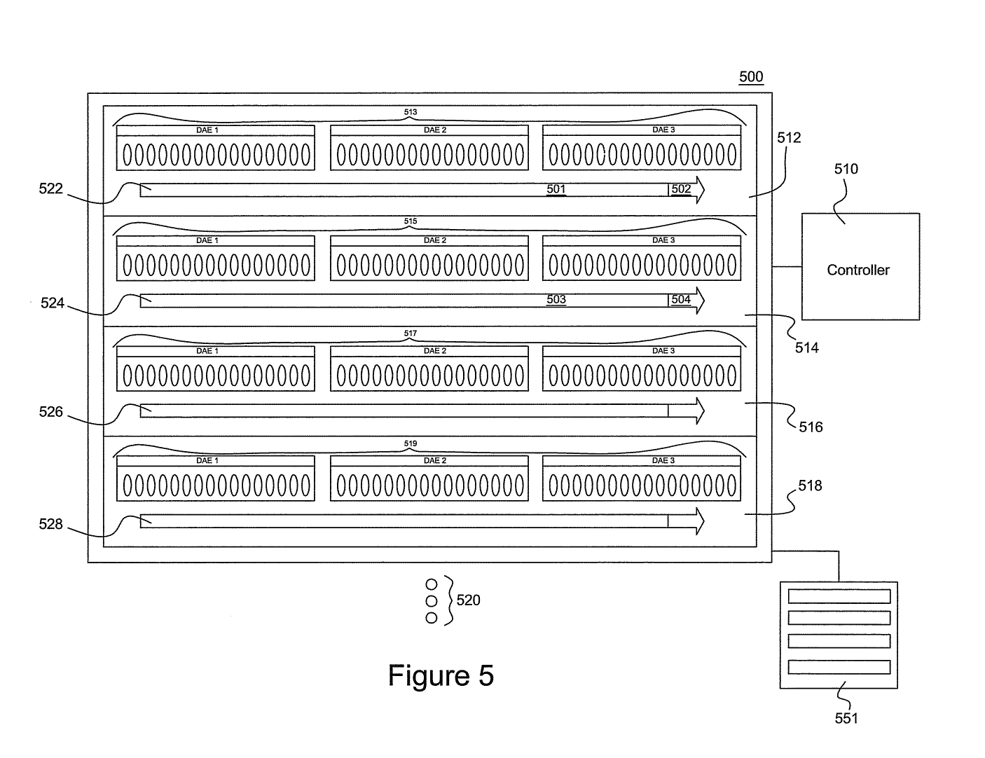

FIG. 5 is a data storage system according to an embodiment of the present subject matter. With reference to FIG. 5, a data storage system 500 is shown having a plurality of hard disk drive units each including a plurality of hard disk drives. Exemplary data storage systems may include, but are not limited to, a storage area network (SAN) or other known storage systems and/or combinations thereof. The system 500 includes a controller 510 that segregates a portion of an aggregate storage volume of the system 500 into a first logical volume 512 and a second logical volume 514. An exemplary controller 510 may be, but is not limited to, a software application. In an alternative embodiment of the present subject matter, the controller 510 may be substituted for plural controllers, e.g., a first and second controller, that segregate portions of the aggregate storage volume of the data storage system 500 into the logical volumes wherein the respective sets of hard disk storage devices are mutually exclusive. Of course, the aggregate storage volume may be segregated into additional logical volumes such as a third logical volume 516, a fourth logical volume 518, and/or a plurality of additional logical volumes 520.

The first logical volume 512 may include a first set 513 of hard disk storage devices for each of a plurality of hard disk drive units DAE1, DAE2, DAE3. The first set 513 of hard disk storage devices comprises storage devices 1 through 16 included on DAE1, storage devices 17 through 32 included on DAE2 and storage devices 33 through 48 included on DAE3. The first set 513 of storage devices may comprise a first RAID set. The second logical volume 514 includes a second set 515 of hard disk storage devices for each of its respective plurality of hard disk drive units DAE1, DAE2, DAE3. The second set 515 of hard disk storage devices comprises storage devices 1 through 16, 17 through 32 and 33 through 48 included on DAE1, DAE2 and DAE3, respectively. The first set 513 and the second set 515 of hard disk storage devices are mutually exclusive of one another. The second set 515 of storage devices may comprise a second RAID set. Of course, additional sets 517, 519 of hard disk storage devices may be included corresponding to the respective third logical volume 516 and fourth logical volume 518, and the additional sets 517, 519 of storage devices may comprise further RAID sets.

The system 500 may also include a first writing circuit (not shown) for storing a first data set 522 in the first logical volume 512 and a second writing circuit (not shown) for storing a second data set 524 in the second logical volume 514. Both the first data set 522 and second data set 524 may include a portion comprising data bits 501, 503 and a portion comprising parity bits 502, 504. The parity bits 502, 504 may also include bits from an error correcting code (ECC). Of course, additional writing circuits may be included in the system 500 for storing additional data sets 526, 528 corresponding to the respective logical volumes 516, 518. Any of the data sets in the system may include information bits from a video stream, audio stream, and/or control files. The hard disk storage devices included in the system 500 may store data sets magnetically, optically, in flash memory, or by another storage means. An additional embodiment of the present subject matter may further include a second data storage system 550 operatively connected to the first storage system 500. The second data storage system 550 may provide back-up storage capacity to the first data storage system 500.

For example, in a system having a high bandwidth requirement, the bandwidth may be increased by interleaving data stripes 522, 524, 526, 528 across multiple RAID sets 513, 515, 517, 519. This interleaving creates a logical volume having an effective bandwidth and capacity equal to the sum of the member RAID sets. Thus, for a system including 4 RAID sets, each set including 48 drives, the bandwidth would be 24 Gbps. Therefore, embodiments of the present subject matter may thus increase the total available bandwidth (and commensurately server channel capacity) and improve expandability of a system or network without sacrificing redundancy or reliability. Further, logical volumes may be added to embodiments of the present subject matter to increase total system capacity up to, but not limited to, 8192 terabytes.

Embodiments of the present subject matter also allow non-interruptive expansion of both capacity and bandwidth. For example, the logical volume may be expanded by dynamically adding additional member RAID sets. Thus, new media may be distributed across all member RAID sets, and existing media may be redistributed across the additional member sets as a background operation. With regard to reliability, if embodiments of the present subject matter suffer double data errors in member RAID sets, performance will not be impacted and media loss will not occur. For example, the parity proportions of the data sets may be maintained and the logical volumes may survive drive data errors equal to two times the number of member RAID sets.

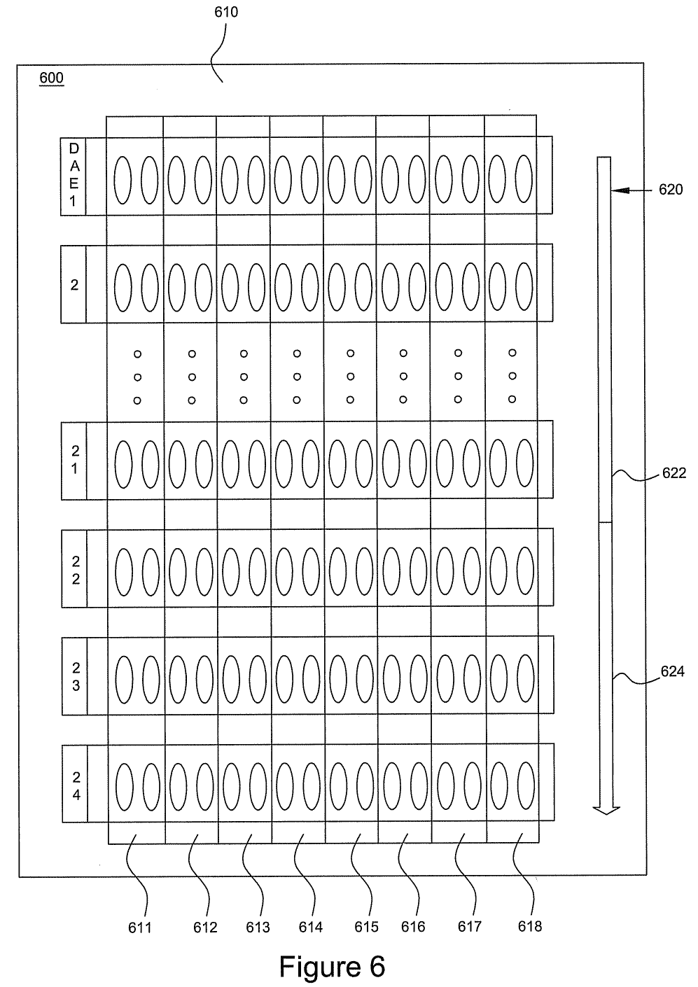

FIG. 6 is a data storage system according to another embodiment of the present subject matter. While traditional data striping arrangements are generally collinear to the physical drive chassis (DAEs), embodiments of the present subject matter may create a higher bandwidth logical volume by arranging the sets of storage devices perpendicular to the DAEs. With reference to FIG. 6, a data storage system 600 is shown having a plurality of hard disk drive units each including a plurality of hard disk drives. The system 600 may include a controller (not shown) that segregates a portion of an aggregate storage volume of the system 600 into at least one logical volume 610. While one logical volume is illustrated, plural logical volumes may be included in the system 600 and such an example is not intended to limit the scope of the claims appended herewith. The logical volume 610 may include a first set 611, second set 612, . . . , seventh set 617, and eighth set 618 of hard disk storage devices arranged perpendicularly to each of a plurality of hard disk drive units DAE1, DAE2, . . . , DAE23, DAE24. While portions of the sets of hard disk storage devices are included on each of the plural hard disk drive units, the sets of hard disk storage devices are mutually exclusive of one another. Of course, the sets of storage devices may comprise RAID sets.

The system 600 may also include one or plural writing circuits (not shown) for storing data sets in the logical volume 610. Any portion of the data set 620 may include a portion comprising data bits 622 and a portion comprising parity bits 624. The parity bits may also include bits from an error correcting code (ECC). Any of the data sets in the system may include information bits from a video stream, audio stream, and/or control files, and the hard disk storage devices included in the system 600 may store data sets magnetically, optically, in flash memory, or by another storage means. Additional data storage systems (not shown) may be operatively connected to the system 600 to provide back-up storage capacity.

Through the perpendicular relationship of the hard disk storage devices or RAID sets and the DAEs of the data storage system 600, higher bandwidth may be realized. This arrangement creates a logical volume having an effective bandwidth and capacity equal to the sum of the member RAID sets. Thus, for a system including 8 RAID sets, each set including 48 drives, the bandwidth would be 48 Gbps. Furthermore, the system 600 exhibits an improved redundancy. For example, an entire drive chassis or DAE may fail without losing media or degrading system performance. That is, because two drives to each RAID set dwell on a given DAE, an entire DAE failure may represent a correctable double data error on each RAID set. In an alternative embodiment of the present subject matter employing ECC-2 parity, 8 RAID sets may be created to utilize all drive slots. Embodiments of the present subject matter may also allow non-interruptive expansion of both capacity and bandwidth. For example, the logical volume may be expanded by adding additional member RAID sets. Thus, new media may be distributed across all member RAID sets, and existing media may be redistributed across the additional member sets. Additional logical volumes may be added to embodiments of the present subject matter to increase total system capacity up to, but not limited to, 8192 terabytes.

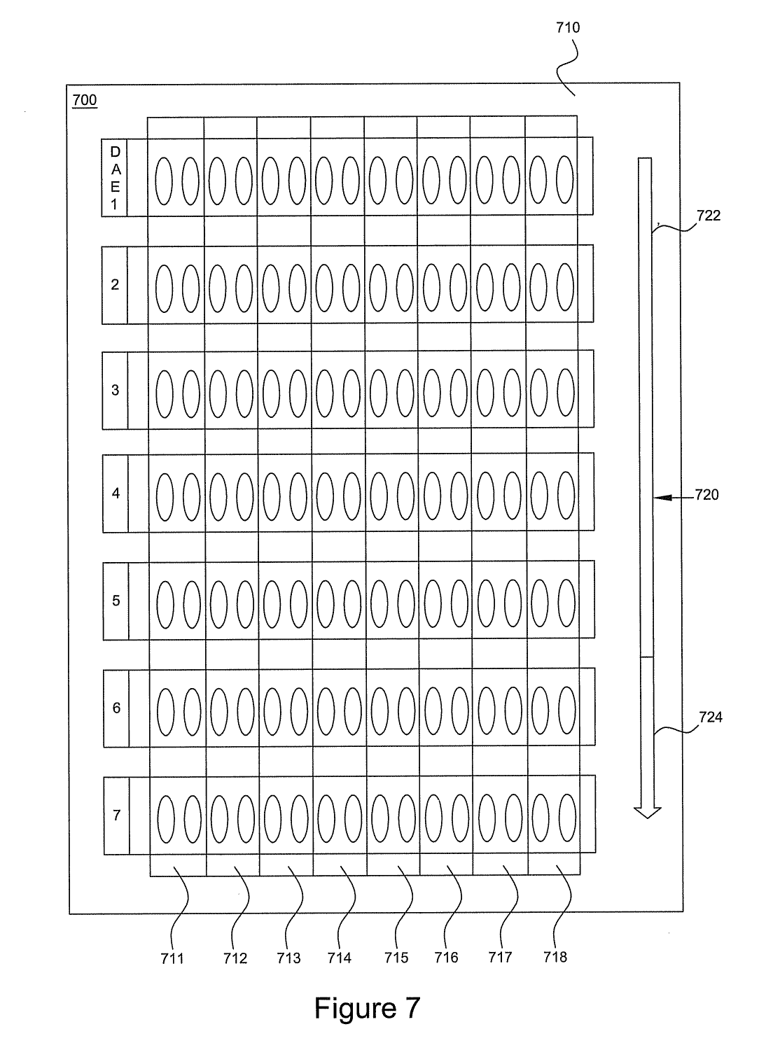

FIG. 7 is a data storage system according to an alternative embodiment of the present subject matter. With reference to FIG. 7, a data storage system 700 is shown having a plurality of hard disk drive units each including a plurality of hard disk drives. The system 700 may include a controller (not shown) that segregates a portion of an aggregate storage volume of the system 700 into at least one logical volume 710. While one logical volume is illustrated, plural logical volumes may be included in the system 700 and such an example is not intended to limit the scope of the claims appended herewith. The logical volume 710 may include plural sets 711 through 718 of hard disk storage devices arranged perpendicularly to each of a plurality of hard disk drive units DAE1 through DAE7. While portions of the sets of hard disk storage devices are included on each of the plural hard disk drive units, the sets of hard disk storage devices are mutually exclusive of one another. Of course, the sets of storage devices may comprise RAID sets. The data storage system 700 illustrates a smaller capacity system having 112 drives. Of course, the system 700 may also include one or plural writing circuits (not shown) for storing a data set 720 in the logical volume 710, and any portion of the data set 720 may include a portion comprising data bits 722 and a portion comprising parity bits 724. The parity bits may also include bits from an ECC. Any of the data sets in the system may include information bits from a video stream, audio stream, and/or control files, and the hard disk storage devices included in the system 700 may store data sets magnetically, optically, in flash memory, or by another storage means. Additional data storage systems may be operatively connected to the system 700 to provide back-up storage capacity.

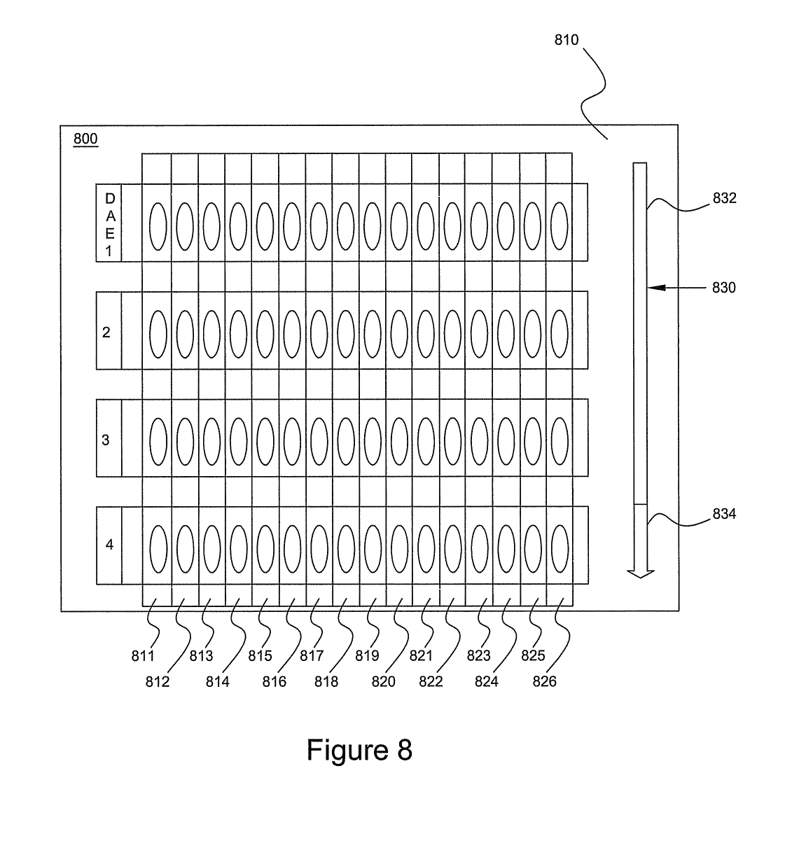

FIG. 8 is a data storage system according to a further alternative embodiment of the present subject matter. With reference to FIG. 8, a data storage system 800 is shown having a plurality of hard disk drive units each including a plurality of hard disk drives. The system 800 may include a controller (not shown) that segregates a portion of an aggregate storage volume of the system 800 into at least one logical volume 810. While one logical volume is illustrated, plural logical volumes may be included in the system 800 and such an example is not intended to limit the scope of the claims appended herewith. The logical volume 810 may include plural sets 811 through 826 of hard disk storage devices arranged perpendicularly to each of a plurality of hard disk drive units DAE1 through DAE4. While portions of the sets of hard disk storage devices are included on each of the plural hard disk drive units, the sets of hard disk storage devices are mutually exclusive of one another. The sets of storage devices may comprise RAID 3 sets. The data storage system 800 illustrates a smaller capacity system having 64 drives. Of course, the system 800 may also include one or plural writing circuits (not shown) for storing a data set 830 in the logical volume 810, and any portion of the data set 830 may include a portion comprising data bits 832 and a portion comprising parity bits 834. The parity bits may also include bits from an ECC. Any of the data sets in the system may include information bits from a video stream, audio stream, and/or control files, and the hard disk storage devices included in the system 800 may store data sets magnetically, optically, in flash memory, or by another storage means. Additional data storage systems may be operatively connected to the system 800 to provide back-up storage capacity.

Additional embodiments of the present subject matter may employ ECC-3, i.e., triple data error correcting. ECC-3 allows embodiments of the present subject matter utilizing perpendicular data striping to lose an entire DAE plus an additional drive with an increase in parity drive overhead. Further embodiments of the present subject matter may also employ RAID 6 to thus reduce parity overhead while retaining double error correction with a corresponding increase in computational overhead.

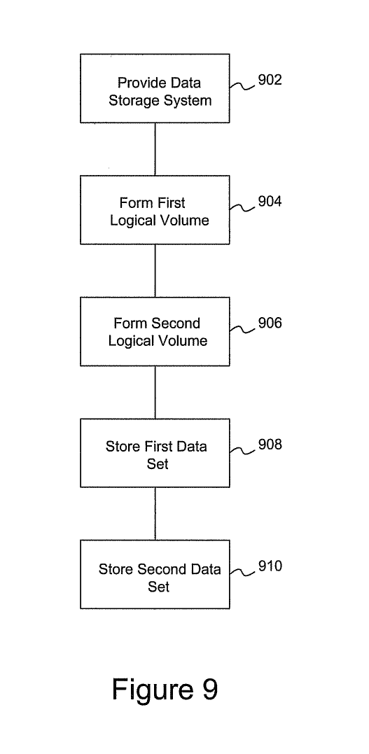

FIG. 9 is a flowchart illustrating a method for storing data in a data storage system according to an embodiment of the present subject matter. With reference to FIG. 9, in step 902, a data storage system is provided having a plurality of hard disk drive units each including a plurality of hard disk storage devices. An exemplary data storage system may include, but is not limited to, a storage area network (SAN) or other known storage system and/or combination thereof. In step 904, a first logical volume is formed for storing data. The first logical volume may include a first set of the hard disk storage devices for each of the hard disk drive units. In step 906, a second logical volume is formed for storing data. The second logical volume may include a second set of the hard disk storage devices for each of the hard disk drive units, wherein the first and second set of hard disk storage devices are mutually exclusive. In step 908, a first data set may be stored in the first logical volume. In step 910, a second data set may be stored in the second logical volume. Both the first data set and second data set may include a portion comprising data bits and a portion comprising parity bits. The parity bits may also include bits from an error correcting code. Any of the data sets may include information bits from a video stream, audio stream, and/or control files. The hard disk storage devices may store the data sets magnetically, optically, in flash memory, or by another storage means. Further embodiments of the present subject matter may include arranging the first and second set of hard disk storage devices into first and second RAID sets, respectively.

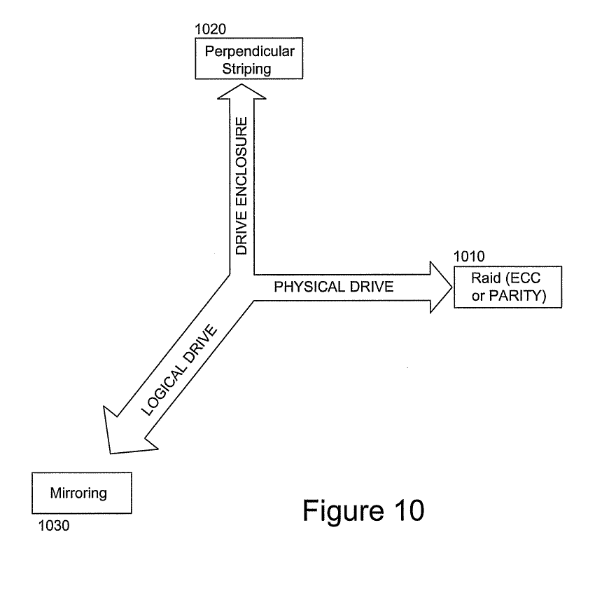

FIG. 10 is a representation of the data storage redundancy capabilities of embodiments of the present subject matter. With reference to FIG. 10, reliability of data storage systems according to the present subject matter may be separated into three independent axes: RAID 1010 (ECC or parity) which eliminates a physical hard drive as a single point failure (SPF); Orthogonal data striping 1020 which eliminates drive and enclosure subsystems as an SPF; and mirroring 1030 which eliminates an entire logical volume as an SPF. The independent nature of the three axes allows them to be combined and tiered. Thus, data storage systems according to embodiments of the present subject matter may employ any one or combination of the three axes to improve reliability, bandwidth, redundancy and storage capacity of a data storage system.

A system according to one embodiment of the present subject matter comprises a data storage system including a plurality of hard disk drive units each of which includes a plurality of hard disk storage devices and a controller which segregates a portion of an aggregate storage volume of the data storage system. The aggregate storage volume may be segregated into a plurality of logical volumes for storing data. For example, the aggregate storage volume may be segregated into a first logical volume for storing data such that a first logical volume includes a first set of the hard disk storage devices for each of the hard disk drive units, and a second logical volume includes a second set of said hard disk storage devices for each of the hard disk drive units, wherein the first and second set of hard disk storage devices are mutually exclusive. The system may also comprise plural writing circuits for storing data sets in the logical volumes. For example, a first writing circuit may be provided for storing a first data set in the first logical volume and a second writing circuit provided for storing a second data set in the second logical volume. An alternative embodiment may include a second data storage system operatively connected to the first storage system to provide back-up storage capacity. Further embodiments may substitute the controller by plural controllers.

A method according to another embodiment of the present subject matter may comprise the steps of providing a data storage system having a plurality of hard disk drive units each of which includes a plurality of hard disk storage devices and forming a first logical volume for storing data such that the first logical volume includes a first set of the hard disk storage devices for each of the hard disk drive units. The method further comprises forming a second logical volume for storing data such that the second logical volume includes a second set of the hard disk storage devices for each of the hard disk drive units, wherein the first and second set of hard disk storage devices are mutually exclusive. A first data set may be stored in the first logical volume, and a second data set may be stored in the second logical volume. Additional embodiments of the present subject matter may include the steps of arranging the first set of hard disk storage devices into a first RAID set and arranging the second set of hard disk storage devices into a second RAID set.

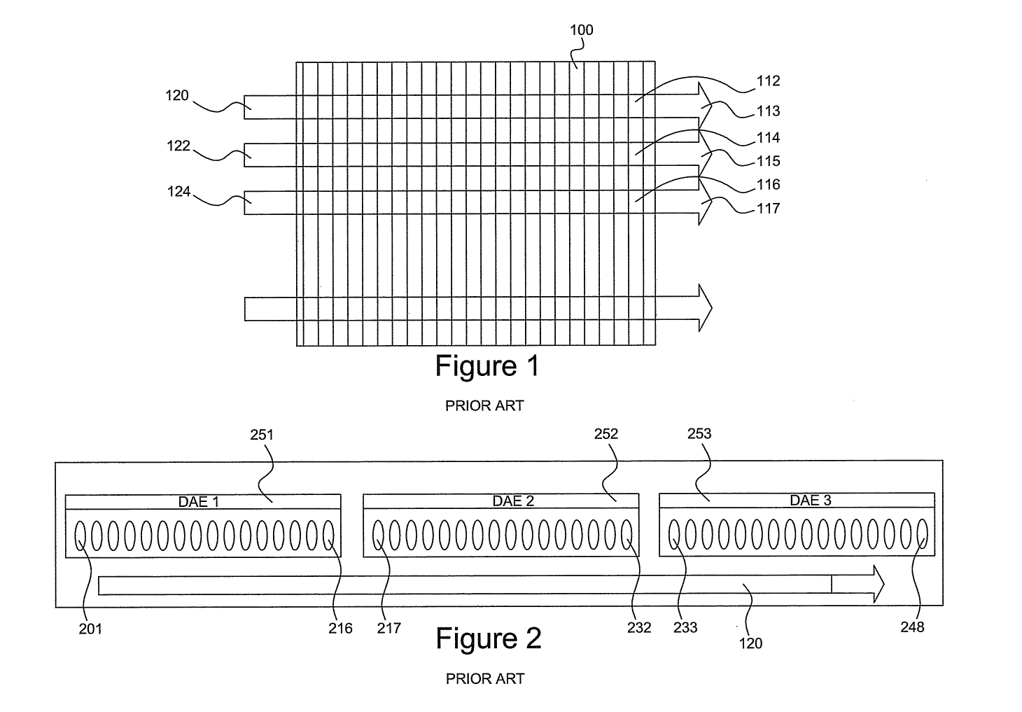

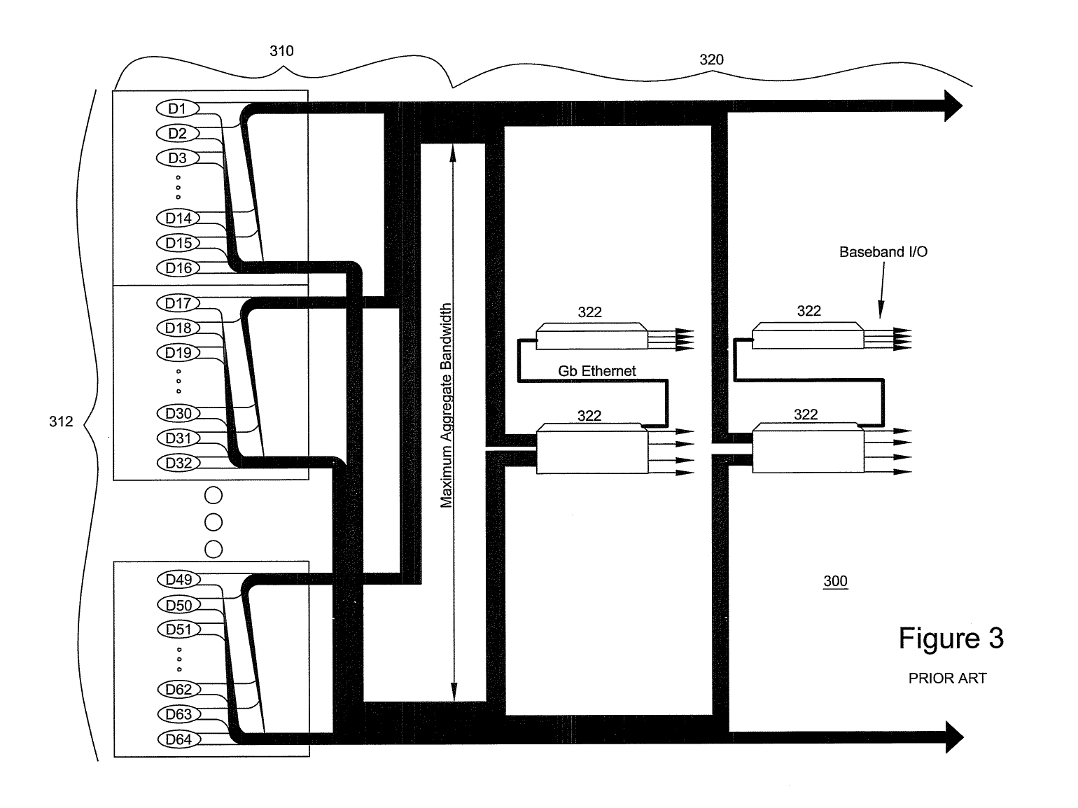

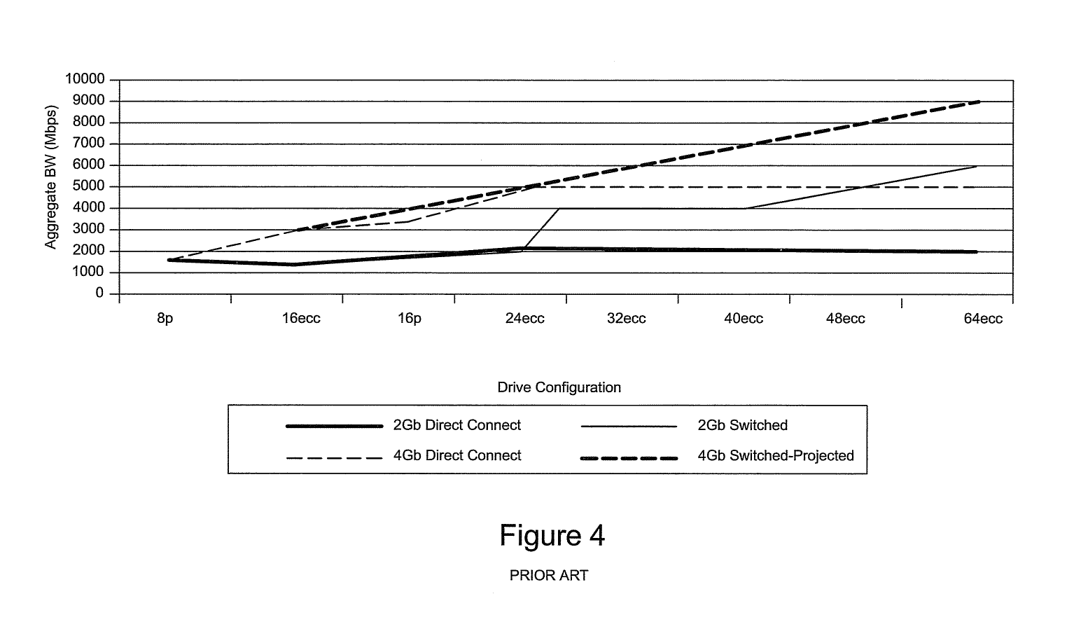

As shown by the various configurations and embodiments illustrated in FIGS. 1-10, a method and system for increasing video server storage bandwidth have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A method for storing data in a data storage system, the method comprising the steps of:
providing a data storage system having a plurality of hard disk drive units each of which includes a plurality of hard disk storage devices;
forming a first logical volume for storing data such that said first logical volume includes a first set of said hard disk storage devices for each of said hard disk drive units;
forming a second logical volume for storing data such that said second logical volume includes a second set of said hard disk storage devices for each of said hard disk drive units;
storing a first data set in said first logical volume; and
storing a second data set in said second logical volume, wherein said first and second set of hard disk storage devices are mutually exclusive.

2. The method of claim 1 further comprising the steps of:
arranging said first set of hard disk storage devices into a first redundant array of independent disks; and
arranging said second set of hard disk storage devices into a second redundant array of independent disks.

3. The method of claim 1 wherein said first data set includes a first portion comprising data bits and a second portion comprising parity bits.

4. The method of claim 3 wherein said parity bits include bits from an error correcting code.

5. The method of claim 1 wherein said first data set includes information bits from a video stream.

6. The method of claim 1 wherein said data storage system is a storage area network.

7. The method of claim 1 wherein said hard disk storage devices store said first data set magnetically.

8. The method of claim 1 wherein said hard disk storage devices store said first data set optically.

9. The method of claim 1 wherein said hard disk storage devices store said first data set in flash memory.

10. A data storage system, comprising:
a data storage system having a plurality of hard disk drive units each of which includes a plurality of hard disk storage devices;
a controller which segregates a portion of an aggregate storage volume of said data storage system into:
(a) a first logical volume for storing data such that said first logical volume includes a first set of said hard disk storage devices for each of said hard disk drive units, and
(b) a second logical volume for storing data such that said second logical volume includes a second set of said hard disk storage devices for each of said hard disk drive units, wherein said first and second set of hard disk storage devices are mutually exclusive;
a first writing circuit for storing a first data set in said first logical volume; and
a second writing circuit for storing a second data set in said second logical volume.

11. The system of claim 10 wherein said first set of hard disk storage devices comprise a first redundant array of independent disks and said second set of hard disk storage devices comprise a second redundant array of independent disks.

12. The system of claim 10 wherein said first data set includes a first portion comprising data bits and a second portion comprising parity bits.

13. The system of claim 12 wherein said parity bits include bits from an error correcting code.

14. The system of claim 10 wherein said first data set includes information bits from a video stream.

15. The system of claim 10 wherein said data storage system is a storage area network.

16. The system of claim 10 wherein said hard disk storage devices store said first data set magnetically.

17. The method of claim 10 wherein said hard disk storage devices store said first data set optically.

18. The method of claim 10 wherein said hard disk storage devices store said first data set in flash memory.

19. The system of claim 10 wherein said controller is a software application.

20. The system of claim 10 wherein said controller is replaced by:
(a) a first controller which segregates a first portion of an aggregate storage volume of said data storage system into said first logical volume for storing data such that said first logical volume includes said first set of said hard disk storage devices for each of said hard disk drive units, and
(b) a second controller which segregates a second portion of said aggregate storage volume of said data storage system into said second logical volume for storing data such that said second logical volume includes said second set of said hard disk storage devices for each of said hard disk drive units, wherein said first and second set of hard disk storage devices are mutually exclusive.

21. The system of claim 10 further comprising a second data storage system operatively connected to said first storage system wherein said second data storage system provides back-up storage capacity to said first data storage system.
